(19) United States
(12) Patent Application Publication
(10) Pub. No.: US 2026/0016647 A1
(43) Pub. Date: Jan. 15, 2026

(54) PACKAGED DEVICES HAVING PHOTONIC INTEGRATED CIRCUITS THEREIN AND METHODS OF FABRICATING THE SAME

(71) Applicant: Samsung Electronics Co., Ltd., Suwon-si (KR)

(72) Inventor: Juhyeon Oh, Suwon-si (KR)

(21) Appl. No.: 19/057,185

(22) Filed: Feb. 19, 2025

(30) Foreign Application Priority Data
Jul. 10, 2024 (KR) 10-2024-0090987

(51) Int. Cl. G02B 6/42

(52) U.S. Cl. CPC G02B 6/425; G02B 6/4214; G02B 6/4255

(57) ABSTRACT

An integrated circuit package includes a photonic integrated circuit die including a first region, which has a first waveguide structure therein, and a second region, which has a connection structure therein. An optical bridge structure has an inclined side surface and a width that narrows in a direction towards the first region of the photonic integrated circuit die, and has a second waveguide structure therein that overlaps a portion of the first waveguide structure in a vertical direction. A first redistribution structure is provided that extends on the second region and is electrically connected to the connection structure within the photonic integrated circuit die; an electronic integrated circuit die extends on and is electrically connected to the first redistribution structure. A reflection pattern is provided on the inclined side surface of the optical bridge structure, along with an optical fiber that overlaps the reflection pattern in the vertical direction.

### REFERENCE TO PRIORITY APPLICATION

This application claims priority to Korean Patent Application No. 10-2024-0090987, filed Jul. 10, 2024, the disclosure of which is hereby incorporated herein by reference.

### BACKGROUND

The present inventive concept relates to integrated circuit packages and, in particular, to integrated circuit packages having photonic integrated circuit dies integrated therein.

In order to meet the demands for miniaturization and high-speed electronic devices, high-speed signal transmission is required. Electronic integrated circuits (EICs) send and receive electrical signals through conductors such as copper wires and conductive metal traces, and therefore have limitations in high-speed signal transmission, whereas photonic integrated circuits (PICs) use optical signals, and therefore enable higher-speed signal transmission. Accordingly, research is being conducted on photonic integrated circuits that include optical elements such as light emitting diodes (LEDs) for generating light, a modulator for converting electrical signals into optical signals, and optical waveguides through which optical signals can be transmitted efficiently.

### SUMMARY

An object of one aspect of the present inventive concept is to provide an integrated circuit package including a photonic integrated circuit die with improved integration and optical characteristics.

However, the objects of the present inventive concept are not limited to those mentioned object, and can be variously extended without departing from the spirit and scope of the present inventive concept.

According to an aspect of the present inventive concept, an integrated circuit package may include: a photonic integrated circuit die comprising a first region comprising a first waveguide structure and a second region comprising a connection structure; an optical bridge structure having an inclined side surface that causes a width thereof to decrease in a direction towards the photonic integrated circuit die on the first region, and further comprising a second waveguide structure overlapping a portion of the first waveguide structure in a vertical direction. A first redistribution structure is provided on the second region; the first redistribution structure is connected to the connection structure. An electronic integrated circuit die is provided on the first redistribution structure, and is connected to the first redistribution structure. A reflection pattern is provided on the inclined side surface of the optical bridge structure, and optical fiber is provided, which overlaps the reflection pattern in the vertical direction.

According to another aspect of the present inventive concept, an integrated circuit package includes a first die comprising a first region comprising a plurality of first waveguides spaced apart from each other in a first horizontal direction and a second region spaced apart from the first region in a second horizontal direction intersecting the first horizontal direction and comprising a connection structure. An optical bridge structure is provided with an inclined side surface, so that a width thereof decreases in a direction towards the first die on the first region; the optical bridge structure includes a plurality of second waveguides extending adjacent to the inclined side surface and spaced apart from each other in the first horizontal direction. A first redistribution structure is provided on the second region, and is connected to the connection structure. A second die is provided on the first redistribution structure, and is connected to the first redistribution structure. A reflection pattern is provided on the inclined side surface of the optical bridge structure, along with an optical fiber that overlaps the reflection pattern in a vertical direction. In some embodiments, each of the plurality of second waveguides may include a first portion overlapping the plurality of first waveguides in the vertical direction and a second portion extending from the first portion and being in contact with the reflection pattern. In some embodiments, a spacing between the plurality of first waveguides is less than a spacing between the second portions of the plurality of second waveguides.

According to another aspect of the present inventive concept, an integrated circuit package may be configured to include a photonic integrated circuit die having a first region therein, which includes a first waveguide extending in a first horizontal direction, and a second region, which is spaced apart from the first region in the first horizontal direction and includes a connection structure. An optical bridge structure is provided, which has an inclined side surface so that a width of the structure decreases toward the photonic integrated circuit die on the first region; the optical bridge structure includes a second waveguide extending adjacent to the inclined side surface and overlapping a portion of the first waveguide in a vertical direction. A first redistribution structure is provided on the second region, and is connected to the connection structure. In addition, a second redistribution structure is provided on a lower surface of the photonic integrated circuit die, and is connected to the connection structure. An electronic integrated circuit die is provided on and is connected to the first redistribution structure. A reflection pattern is provided on the inclined side surface of the optical bridge structure, along with an optical fiber that overlaps the reflection pattern in the vertical direction. In some embodiments, a first distance in the first horizontal direction between the first waveguide and the reflection pattern is greater than a second distance in the first horizontal direction between the second waveguide and the reflection pattern.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a cross-sectional view of an integrated circuit package according to an embodiment of the present inventive concept;

FIG. 2 is a cross-sectional view of an integrated circuit package according to another embodiment of the present inventive concept;

FIG. 3 is a cross-sectional view of an integrated circuit package according to another embodiment of the present inventive concept;

FIG. 4A is a schematic perspective view of an integrated circuit package showing an uninterrupted path of an optical signal transmitted to an optical fiber of an integrated circuit package according to an embodiment of the present inventive concept;

FIG. 4B is a schematic perspective view of an integrated circuit package illustrating a path of an optical signal transmitted to an optical fiber of an integrated circuit package according to another embodiment of the present inventive concept;

FIG. 5 is a cross-sectional view illustrating a package module device including the integrated circuit package of FIG. 1;

FIGS. 6A to 6C are drawings illustrating an embodiment of a method for manufacturing an optical bridge structure of FIG. 1; and

FIGS. 7A to 7F are drawings illustrating an embodiment of a method for manufacturing an integrated circuit package of FIG. 1.

### DETAILED DESCRIPTION

Hereinafter, example embodiments of the present inventive concept will be described with reference to the accompanying drawings. The same reference numerals are used for the same components in the drawings, and duplicate descriptions for the same components are omitted.

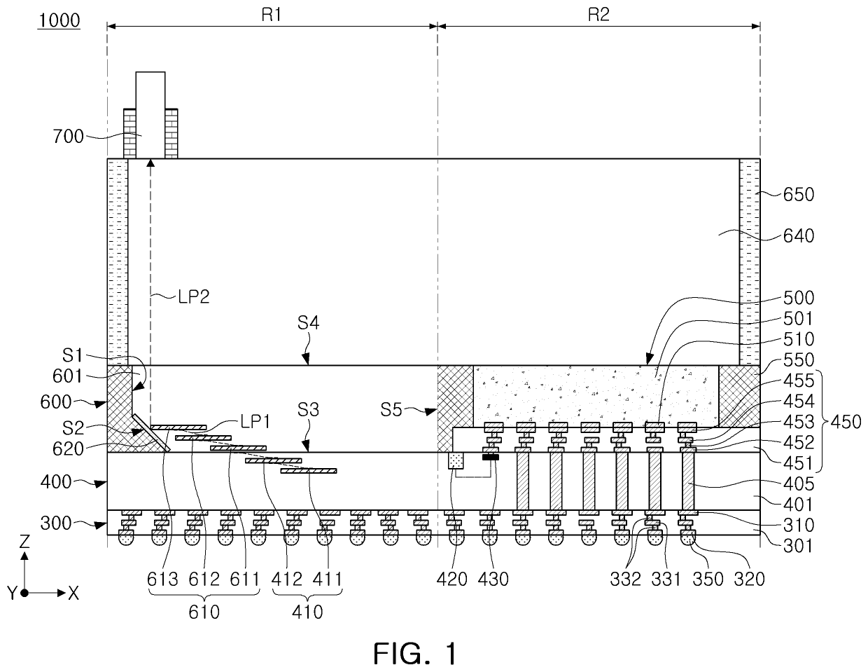

FIG. 1 is a cross-sectional view of an integrated circuit package 1000 according to an embodiment of the present inventive concept. Referring to FIG. 1, the integrated circuit package 1000 may include a photonic integrated circuit die 400, an electronic integrated circuit die 500 disposed on an upper surface of the photonic integrated circuit die 400 and connected to the photonic integrated circuit die 400, an optical bridge structure 600 disposed on the upper surface of the photonic integrated circuit die 400 and spaced apart from the electronic integrated circuit die 500, a first redistribution structure 450 disposed between the photonic integrated circuit die 400 and the electronic integrated circuit die 500, a second redistribution structure 300 disposed on a lower surface of the photonic integrated circuit die 400, a dummy structure 640 disposed on the optical bridge structure 600, and an optical fiber 700 disposed on the dummy structure 640. The integrated circuit package 1000 may be referred to as a first semiconductor structure herein, and may also be referred to herein as an integrated circuit (IC) package.

According to some embodiments, the photonic integrated circuit (PIC) die 400 may be a processor, a modem, an interface, a system-on-chip (SoC), various devices using optical communications or optical signal processing, or a combination thereof, or may be included in the above-described configurations and used to perform optical communications or optical signal processing. The photonic integrated circuit die 400 may be referred to as a first die herein.

The photonic integrated circuit die 400 may include a photonic integrated circuit substrate 401, a first waveguide structure 410, a modulator 420, a passive element 430 connected to the modulator 420, and a connection structure 405. The photonic integrated circuit substrate 401 may include a semiconductor material, for example, a group IV semiconductor such as silicon, germanium, or silicon-germanium. The photonic integrated circuit substrate 401 may be provided as a bulk wafer or an epitaxial layer. The first waveguide structure 410, the modulator 420, and the passive element 430 may be embedded and disposed in the photonic integrated circuit substrate 401, and the connection structure 405, which penetrates the photonic integrated circuit substrate 401, may be disposed therein. The photonic integrated circuit substrate 401 may be referred to as an optic printed circuit board (optic PCB or OPCB). In addition, the photonic integrated circuit substrate 401 may include an upper surface and a lower surface facing the upper surface. In one example, as shown, the optical bridge structure 600 and the electronic integrated circuit die 500 spaced apart from the optical bridge structure 600 may be disposed on the upper surface of the photonic integrated circuit substrate 401.

The upper surface of the photonic integrated circuit die 400 may include a first region R1 and a second region R2 spaced apart from the first region R1 in a first direction (X-direction). The optical bridge structure 600 may be disposed on the first region R1 of the photonic integrated circuit die 400, and the first redistribution structure 450 may be disposed on the second region R2. In an example, the upper surface of the photonic integrated circuit die 400 may be in contact with a lower surface of the optical bridge structure 600 and a lower surface of the first redistribution structure 450. The lower surface of the photonic integrated circuit die 400 may be in contact with an upper surface of the second redistribution structure 300.

The connection structure 405 disposed in the photonic integrated circuit substrate 401 may include vertically-extending through-hole electrodes penetrating the photonic integrated circuit substrate 401. The connection structure 405 may extend from the upper surface to the lower surface of the photonic integrated circuit substrate 401 and penetrate the photonic integrated circuit substrate 401. In an example, the connection structure 405 may connect the first redistribution structure 450 and the second redistribution structure 300. The connection structure 405 may connect a first lower pad 452 of the first redistribution structure 450 and a second upper pad 310 of the second redistribution structure 300. In an example, when the photonic integrated circuit substrate 401 is made of silicon, the connection structure 405 may be referred to as a through silicon via (TSV).

The first waveguide structure 410, the modulator 420, and the passive element 430 embedded in the photonic integrated circuit substrate 401 may be optical elements, and the passive element 430 may be electrically connected to the electronic integrated circuit die 500 through the first redistribution structure 450 to detect an electrical signal and transmit or receive an optical signal. The modulator 420 may be connected to the passive element 430 and the first waveguide structure 410, convert the electrical signal detected through the passive element 430 into an optical signal and output the converted optical signal to the first waveguide structure 410.

The first waveguide structure 410 may overlap the optical bridge structure 600 disposed on the first region R1 of the photonic integrated circuit die 400 in a vertical direction (Z-direction). In an example, the first waveguide structure 410 may include at least one optical waveguide as a path through which an optical signal travels. The first waveguide structure 410 may include a (1-1)-th waveguide 411 and a (1-2)-th waveguide 412 disposed above the (1-1)-th waveguide 411. A portion of the (1-1)-th waveguide 411 may overlap a portion of the (1-2)-th waveguide 412 in the vertical direction (Z-direction). In an example, the first waveguide structure 410 may be a path of an optical signal output through the modulator 420. The optical signal output through the modulator 420 may be transmitted to the (1-1)-th waveguide 411 and the (1-2)-th waveguide 412.

The modulator 420 may be disposed adjacent to the first waveguide structure 410 in the photonic integrated circuit substrate 401, and may be connected to the passive element 430. The modulator 420 may modulate an electrical signal received from an external source into an optical signal.

The passive element 430 may overlap the first redistribution structure 450 disposed on the second region R2 of the photonic integrated circuit substrate 401 in the vertical direction (Z-direction). In another embodiment, the passive element 430 may be disposed in the first region R1 of the photonic integrated circuit substrate 401, and may be electrically connected to the first redistribution structure 450.

According to some embodiments, the passive element 430 may be a photodetector. The photodetector may be a photoelectric conversion element converting an optical signal into an electrical signal. That is, the passive element 430 may output electrical signals, which are generated in response to converting optical signals, and may transmit the electrical signals to the electronic integrated circuit die 500.

The optical bridge structure 600 may be disposed on the first region R1 of the photonic integrated circuit die 500. The optical bridge structure 600 may overlap the first waveguide structure 410 of the photonic integrated circuit die 400 in the vertical direction (Z-direction). The optical bridge structure 600 may be spaced apart from the first redistribution structure 450 and the electronic integrated circuit die 500 in the first direction (X-direction), and may not overlap the connection structure 405 of the photonic integrated circuit die 400 in the vertical direction (Z-direction).

The optical bridge structure 600 may include an optical bridge substrate 601, a second waveguide structure 610, and a reflection pattern 620. As shown, the optical bridge substrate 601 may be disposed on the first region R1 of the photonic integrated circuit substrate 401. The optical bridge substrate 601 may include a first side surface S1 adjacent to an edge of the photonic integrated circuit die 400, a second side surface S5 facing the first side surface S1 and adjacent to the electronic integrated circuit die 500, a lower surface S3 contacting the photonic integrated circuit die 400, an upper surface S4 facing the lower surface S3 and contacting the dummy structure 640, and an inclined side surface S2 of which a width decrease toward the photonic integrated circuit die 400 between the first side surface S1 and the lower surface S3.

The optical bridge substrate 601 may include a semiconductor material, such as a group IV semiconductor, a group III-V compound semiconductor, or a group II-IV compound semiconductor. For example, the group IV semiconductor may include silicon, germanium, or silicon-germanium. The optical bridge substrate 601 may be provided as a bulk wafer, an epitaxial layer, a silicon on insulator (SOI), or a semiconductor on insulator (SeOI) layer, etc.

The second waveguide structure 610 may be embedded in the optical bridge substrate 601. The reflection pattern 620 may be adjacent to the second waveguide structure 610 and disposed on an inclined side surface S2 in the optical bridge substrate 601. The second waveguide structure 610 may be embedded in the optical bridge substrate 601 in an area adjacent to the lower surface of the optical bridge structure 600, and may overlap a portion of the first waveguide structure 410 of the photonic integrated circuit die 400. The second optical waveguide structure 610 may form a path through which an optical signal travels together with the first waveguide structure 410, and may include at least one optical waveguide. The second waveguide structure 610 may be a path of an optical signal transmitted from the first waveguide structure 410.

The second optical waveguide structure 610 may include a (2-1)-th waveguide 611, a (2-2)-th waveguide 612 disposed above the (2-1)-th waveguide 611 and overlapping a portion of the (2-1)-th waveguide 611, and a (2-3)-th waveguide 613 disposed above the (2-2)-th waveguide 612 and overlapping a portion of the (2-2)-th waveguide 612. In an example, the (2-1)-th waveguide 611 of the second waveguide structure 610 may be disposed above the (1-2)-th waveguide 412 of the first waveguide structure 410, and may overlap a portion of the (1-2)-th waveguide 412 in a vertical direction.

The (1-1)-th waveguide 411, the (1-2)-th waveguide 412, the (2-1)-th waveguide 611, the (2-2)-th waveguide 612, and the (2-3)-th waveguide 613 may be disposed in a stepwise manner in the first direction (X-direction). The integrated circuit package 1000 may include the (2-3)-th waveguide 613, the (2-2)-th waveguide 612, the (2-1)-th waveguide 611, the (1-2)-th waveguide 412, and the (1-1)-th waveguide 411 that are sequentially arranged in the first direction (X-direction) and form a step shape.

The reflection pattern 620 may be disposed on the inclined side surface S2 of the optical bridge substrate 601. The reflection pattern 620 may be in contact with an end of the (2-3)-th waveguide 613 of the second waveguide structure 610. The reflection pattern 620 may act as changing a path of an optical signal. In an example, the reflection pattern 620 may change a first optical signal LP1 traveling in a horizontal direction into a second optical signal LP2 traveling in the vertical direction. The reflection pattern 620 may be an optical path conversion element changing a direction of an optical signal by 90° between the second waveguide structure 610 and the optical fiber 700 to transmit light. In an example, the reflection pattern 620 may be disposed at an angle of about 38° to about 52° with respect to the lower surface S3 of the optical bridge structure 600.

The reflection pattern 620 may include a metal material layer, and may include, for example, a metal material such as Au, Ag, Al, Mg, Cu, Pt, Pd, Ni, Cr, and/or TiO₂.

A distance between the reflection pattern 620 and the first optical waveguide structure 410 in the first direction (X-direction) may be greater than a distance between the reflection pattern 620 and the second optical waveguide structure (620) in the first direction (X-direction).

An optical signal output through the modulator 420 may be transmitted to the reflection pattern 620 by evanescent coupling through the first waveguide structure 410 and the second waveguide structure 610 disposed on the first waveguide structure 410. In an example, the optical signal output through the modulator 420 may move in a lateral direction with respect to an X-axis near a first end of the (1-1)-th waveguide 411, and may be transmitted to the (1-2)-th waveguide 412 near a first end of a (1-2)-th waveguide 412 partially overlapping the (1-1)-th waveguide 411 in the vertical direction. In addition, the optical signal transmitted to the (1-2)-th waveguide 412 may move in a lateral direction of the (1-2)-th waveguide 412 with respect to the X-axis, and may be transmitted to the (2-1)-th waveguide 611 near a first end of the (2-1)-th waveguide 611 partially overlapping the (1-2)-th waveguide 412 in the vertical direction. The optical signal transmitted to the (2-1)-th waveguide 611 may move in a lateral direction of the (2-1)-th waveguide 611 with respect to the X-axis, and may be transmitted to the (2-2)-th waveguide 612 near a first end of the (2-2)-th waveguide 612 overlapping the (2-1)-th waveguide 611 in the vertical direction. The optical signal transmitted to the (2-2)-th waveguide 612 may move in a lateral direction of the (2-2)-th waveguide 612 with respect to the X-axis, and may be transmitted to the (2-3)-th waveguide 613 near a first end of the (2-3)-th waveguide 613 partially overlapping the (2-2)-th waveguide 612 in the vertical direction. The optical signal transmitted to the (2-3)-th waveguide 613 may move in a lateral direction of the (2-3)-th waveguide 613 with respect to the X-axis, may be changed in a path of the optical signal by the reflection pattern 620, and may pass through the optical bridge substrate 601 and the dummy structure 640 in the vertical direction (Z-direction) to be transmitted to the optical fiber 700.

The first redistribution structure 450 may be disposed on the second region R2 of the photonic integrated circuit die 500. The first redistribution structure 450 may be spaced apart from the optical bridge structure 600 in the first direction (X-direction). In an example, the lower surface of the first redistribution structure 450 may be disposed on the same level as the lower surface of the optical bridge structure 600. As shown, the first redistribution structure 450 may include a first substrate 451, a first lower interconnection layer 453 and 454, a first lower pad 452 disposed on a lower surface of the first substrate 451, and a first upper pad 455 disposed on an upper surface of the first substrate 451.

The first substrate 451 may operates as a support substrate on which the electronic integrated circuit die 500 is provided, and may be an integrated circuit package substrate including a printed circuit board (PCB), a ceramic substrate, a glass substrate, a tape wiring substrate, and the like. The first lower interconnection layer 453 and 454 may be embedded in the first substrate 451 to electrically connect the first upper pad 455 and the first lower pad 452. The first lower interconnection layer 453 and 454 may include a first interconnection 454 and a first contact plug 453. However, the present inventive concept is not limited thereto, and a structure of the first lower interconnection layer 453 and 454 may be variously changed. The first lower interconnection layer 453 and 454 may be referred to as a first lower interconnection structure or a first circuit interconnection structure herein.

The first upper pad 455, the first lower pad 452, and the first lower interconnection layer 453 and 454 may form an electrical path connecting the upper surface and the lower surface of the first substrate 451. The first upper pad 455, the first lower pad 452, and the first lower interconnection layer 453 and 454 may include a metal material. The above metal material may include at least one metal selected from the group consisting of copper (Cu), aluminum (Al), nickel (Ni), silver (Ag), gold (Au), platinum (Pt), tin (Sn), lead (Pb), titanium (Ti), chromium (Cr), palladium (Pd), indium (In), zinc (Zn) or carbon (C), or an alloy including two or more metals.

The electronic integrated circuit die 500 may be disposed on the first redistribution structure 450. The electronic integrated circuit die 500 may overlap the second region R2 of the photonic integrated circuit substrate 401 in the vertical direction (Z-direction). The electronic integrated circuit die 500 may be spaced apart from the optical bridge structure 600 in the first direction (X-direction), and an upper surface of the electronic integrated circuit die 500 may be disposed on the same level as the upper surface S4 of the optical bridge structure 600. The electronic integrated circuit die 500 may be referred to as a second die herein.

The electronic integrated circuit die 500 may include an electronic integrated circuit substrate 501 and a connection pad 510 disposed on a lower surface of the electronic integrated circuit substrate 501. In an example, the electronic integrated circuit die 500 may receive data (DATA) from an external device and transmit an electrical signal to the passive element 430 through the first redistribution structure 450 based on the data.

A bonding of the first upper pad 455 and the connection pad 510 may be a copper-copper (Cu—Cu) bonding, and the electronic integrated circuit die 500 and the first redistribution structure 450 may be bonded by a hybrid bonding including a copper-copper (Cu—Cu) bonding and a dielectric-dielectric bonding. However, the present inventive concept is not limited thereto. In another embodiment, the electronic integrated circuit die 500 and the first redistribution structure 450 may be bonded through a connection bump (not shown) between the first upper pad 455 and the connection pad 510. A height of the electronic integrated circuit die 500 in the vertical direction may be about 25 μm to about 50 μm in some embodiments.

The integrated circuit package 1000 may further include a first mold portion 550 disposed on the photonic integrated circuit die 400. The first mold portion 550 may cover a side surface of the optical bridge structure 600, a side surface and an upper surface of the first redistribution structure 450, and a side surface of the electronic integrated circuit die 500. In an example, the first mold portion 550 may expose an upper surface of the optical bridge structure 600 and an upper surface of the electronic integrated circuit die 500. An upper surface of the first mold portion 550 may be disposed on the same level as the upper surface of the optical bridge structure 600 and the upper surface of the electronic integrated circuit die 500. The first mold portion 550 may fill a space between the inclined side surface S2 of the optical bridge structure 600 and the photonic integrated circuit die 400.

The first mold portion 550 may include a first mold material. The first mold material may include a material for relieving stress applied to the photonic integrated circuit die 400, the optical bridge structure 600, and the electronic integrated circuit die 500. For example, the first mold material may include a TEOS (TetraEthyl Ortho Silicate) oxide.

The dummy structure 640 may be disposed on the optical bridge structure 600 and the electronic integrated circuit die 500. The dummy structure 640 may overlap the optical bridge structure 600 and the electronic integrated circuit die 500 in the vertical direction (Z-direction). A lower surface of the dummy structure 640 may be disposed on the same level as the upper surface of the first mold portion 550, the upper surface of the optical bridge structure 600, and the upper surface of the electronic integrated circuit die 500. The dummy structure 640 may include a semiconductor material, such as a group IV semiconductor, a group III-V compound semiconductor, or a group II-IV compound semiconductor. For example, the group IV semiconductor may include silicon, germanium, or silicon-germanium. The optical bridge substrate 601 may be provided as a bulk wafer, an epitaxial layer, a silicon on insulator (SOI), or a semiconductor on insulator (SeOI) layer, etc. In an example, the dummy structure 640 may include the same material as the optical bridge substrate 601 of the optical bridge structure 600. According to some embodiments, a height of the dummy structure 640 in the vertical direction (Z-direction) may be about 600 μm. The dummy structure 640 may be a structure for preventing warpage of the integrated circuit package 1000.

The integrated circuit package 1000 may further include a second mold portion 650 surrounding a side surface of the dummy structure 640. The second mold portion 650 may expose an upper surface of the dummy structure 640. In an example, the second mold portion 650 may include a second mold material, such as a sealing resin. The second mold material of the second mold portion 650 may be different from the first mold material of the first mold portion 550. For example, the second mold material may include an epoxy molding compound (EMC). However, the present inventive concept is not limited thereto. In another embodiment, the first mold material of the first mold portion 550 may include the same material as the second mold material of the second mold portion 650. A side surface of the first mold portion 550 and a side surface of the second mold portion 650 may form a coplanar plane

The optical fiber 700 may be disposed on the dummy structure 640. The optical fiber 700 may be in direct contact with the upper surface of the dummy structure 640. The optical fiber 700 may overlap the first region R1 of the photonic integrated circuit substrate 401 of the photonic integrated circuit die 400 in the vertical direction (Z-direction). In an example, an optical signal whose direction of travelling is changed by the reflection pattern 620 of the optical bridge structure 600 may pass through the optical bridge substrate 601 and the dummy structure 640, and be transmitted to the optical fiber 700. The optical fiber 700 may overlap the reflection pattern 620 in the vertical direction (Z-direction).

The second redistribution structure 300 may be placed on the lower surface of the photonic integrated circuit substrate 401. The second redistribution structure 300 may completely overlap the photonic integrated circuit die 400 in the vertical direction (Z-direction). The second redistribution structure 300 may overlap the first region R1 and the second region R2 of the photonic integrated circuit substrate 401 in the vertical direction (Z-direction). In an example, the second redistribution structure 300 may overlap the optical bridge structure 600 and the electronic integrated circuit die 500 on the upper surface of the photonic integrated circuit die 400 in the vertical direction (Z-direction)

The second redistribution structure 300 may include a second substrate 301, a second upper pad 310 disposed on an upper surface of the second substrate 301, a second lower pad 320 disposed on a lower surface of the second substrate 301, a second lower interconnection layer 331 and 332 connecting the second upper pad 310 and the second lower pad 320, and an external connection terminal 350 disposed on the lower surface of the second substrate 301.

The second substrate 301 is a support substrate on which the photonic integrated circuit die 400 is mounted, and may be an integrated circuit package substrate including a printed circuit board (PCB), a ceramic substrate, a glass substrate, a tape wiring substrate, and the like. In an example, the second substrate 301 may include a different material depending on a type of the substrate. For example, if the second substrate 301 is a printed circuit board, it may be in the form of an additional interconnection layer stacked on one or both surfaces of a copper-clad stack. In an example, a solder resist layer may be disposed on the lower surface and the upper surface of the second substrate 301. The second substrate 301 may include features identical or similar to those of the first substrate 451.

The second lower interconnection layer 331 and 332 may be embedded in the second substrate 301 to electrically connect the second upper pad 310 and the second lower pad 320. The second lower interconnection layer 331 and 332 may include a second interconnection 331 and a second contact plug 332. However, the present inventive concept is not limited thereto, and a structure of the second lower interconnection layer 331 and 332 may be variously changed. The second lower interconnection layer 331 and 332 may be referred to as a second lower interconnection structure or a second circuit interconnection structure herein.

The second upper pad 310, the second lower pad 320, and the second lower interconnection layer 331 and 332 may form an electrical path connecting the upper surface and the lower surface of the second substrate 301. The second upper pad 310, the second lower pad 320, and the second lower interconnection layer 331 and 332 may include a metal material. The above metal material may include at least one metal selected from the group consisting of copper (Cu), aluminum (Al), nickel (Ni), silver (Ag), gold (Au), platinum (Pt), tin (Sn), lead (Pb), titanium (Ti), chromium (Cr), palladium (Pd), indium (In), zinc (Zn), or carbon (C), or an alloy including two or more metals.

The external connection terminal 350 may be disposed on the lower surface of the second substrate 301, and may be electrically connected to the second lower pad 320. The external connection terminal 350 may include tin (Sn), indium (In), bismuth (Bi), antimony (Sb), copper (Cu), silver (Ag), zinc (Zn), lead (Pb), and/or alloys thereof.

The integrated circuit package according to embodiments of the present inventive concept may include the photonic integrated circuit die 400 including the first waveguide structure 410 and the optical modulator 420, the electronic integrated circuit die 500 disposed on the photonic integrated circuit die 400 and connected to the photonic integrated circuit die 400, the optical bridge structure 600 disposed on the photonic integrated circuit die 400 and including the second waveguide structure 610 and the reflection pattern 620 forming a path of an optical signal together with the first waveguide structure 410, and the optical fiber 700 on the optical bridge structure 600. Accordingly, an integrated circuit package with improved degrees of freedom and integration of a path through which an optical signal is transmitted may be provided.

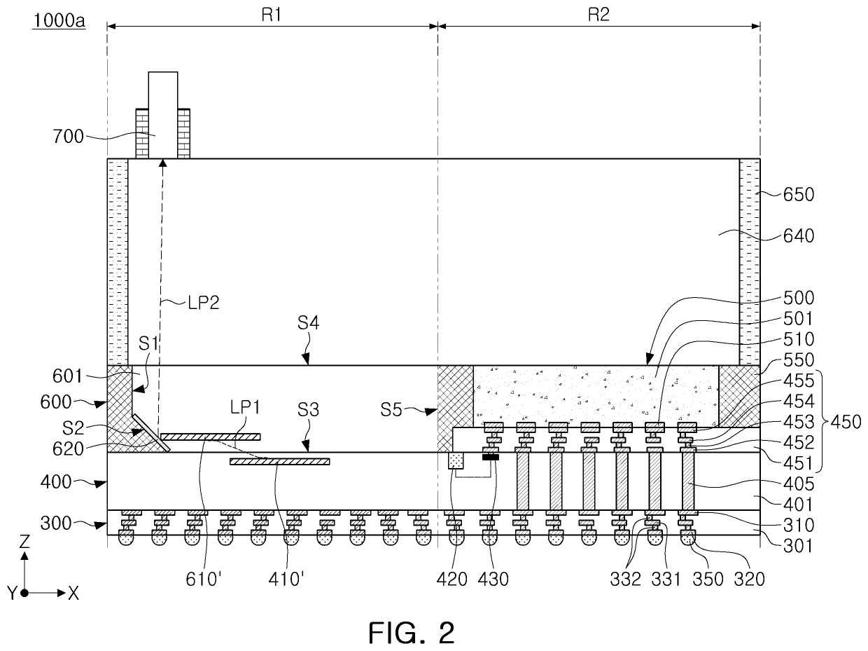

FIG. 2 is a cross-sectional view of an integrated circuit package 1000a according to another embodiment of the present inventive concept. Referring to FIG. 2, the remaining configurations except for a first waveguide structure 410′ and a second waveguide structure 610′ of the integrated circuit package 1000a may be identical or corresponding to the configurations illustrated in FIG. 1. For the components among the configurations that are identical or corresponding to the configurations illustrated in FIG. 1 except for the first waveguide structure 410′ and the second waveguide structure 610′, a duplicate description will be omitted.

The first waveguide structure 410′ may overlap an optical bridge structure 600 disposed on the first region R1 of a photonic integrated circuit die 400 in the vertical direction (Z-direction). In an example, the first waveguide structure 410′ may form an optical waveguide as a path through which an optical signal travels. An optical signal output through a modulator 420 may be transmitted to the first waveguide structure 410′. In an example, the first waveguide structure 410′ may include a plurality of waveguides extending in the first direction (X-direction) and spaced apart in a second direction (Y-direction) intersecting the first direction (X-direction).

The second waveguide structure 610′ may be embedded in an optical bridge substrate 601 and disposed on the first waveguide structure 410′ of the photonic integrated circuit die 400, so as to overlap a portion of the first waveguide structure 410′. The second waveguide structure 610′ may be an optical waveguide forming a path through which an optical signal travels together with the first waveguide structure 410′. In an example, the second waveguide structure 610′ may be a path of an optical signal transmitted from the first waveguide structure 410′. In an example, the second waveguide structure 610′ may include a plurality of waveguides disposed on the first waveguide structure 410′, extending in the first direction (X-direction), and spaced apart from each other in the second direction (Y-direction) intersecting the first direction (X-direction). The second end of the second waveguide structure 610′ may be in contact with the reflection pattern 620.

The optical signal output through the modulator 420 may be transmitted to a reflection pattern 620 by evanescent coupling through the first waveguide structure 410′ and the second waveguide structure 610′ disposed on the first waveguide structure 410′ and overlapping a portion of the first waveguide structure 410′ in the vertical direction (Z-direction).

The optical signal output through the modulator 420 may approach a first end of the first waveguide structure 410′ and move in a lateral direction with respect to an X-axis, and may be transmitted to the second waveguide structure 610′ near a first end of the second waveguide structure 610′ partially overlapping the first waveguide structure 410′ in the vertical direction (Z-direction). The optical signal transmitted to the second waveguide structure 610′ may move in a lateral direction of the second waveguide structure 610′ with respect to the X-axis, be changed in a path of the optical signal by the reflection pattern 620, and pass through the optical bridge substrate 601 and a dummy structure 640 in the vertical direction (Z-direction) to be transmitted to an optical fiber 700.

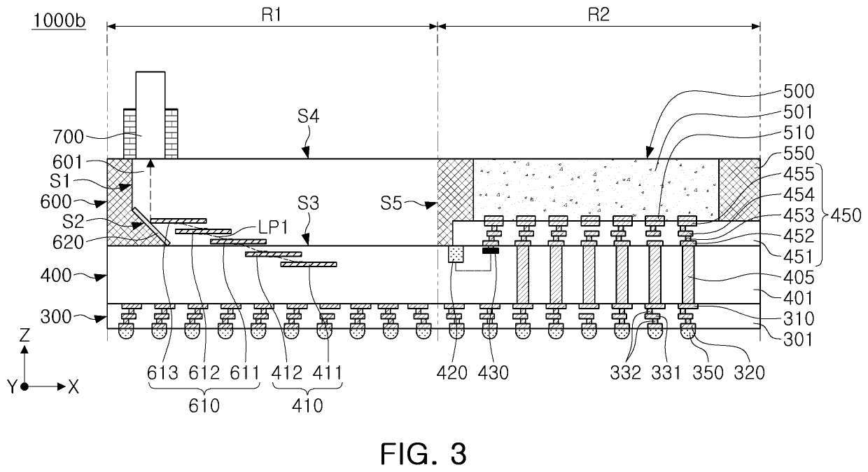

FIG. 3 is a cross-sectional view of an integrated circuit package 1000b according to another embodiment of the present inventive concept. Referring to FIG. 3, the remaining configurations of the integrated circuit package 1000b except for the optical fiber 700 may be identical or corresponding to the configurations illustrated in FIG. 1. As shown, the optical fiber 700 may be directly disposed on an optical bridge structure 600. The optical signal whose direction of travelling is changed by a reflection pattern 620 of an optical bridge structure 600 may pass through an optical bridge substrate 601 of the optical bridge structure 600 and be directly transmitted to the optical fiber 700.

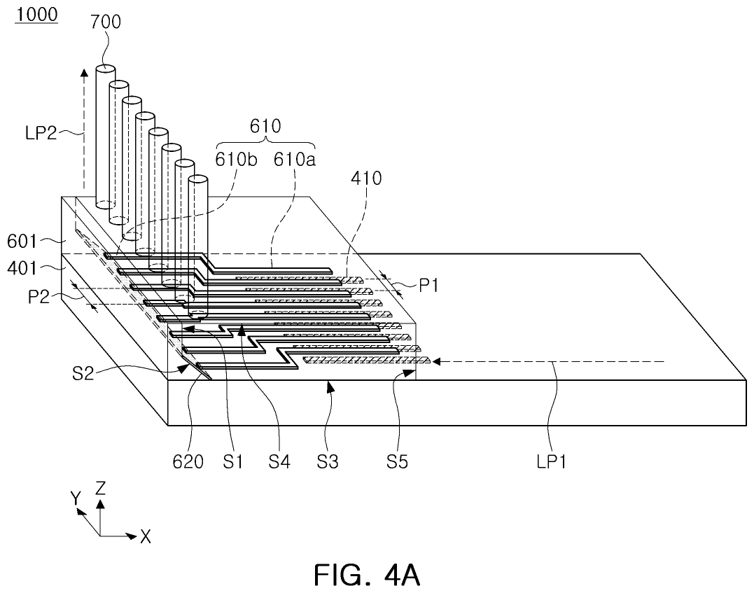

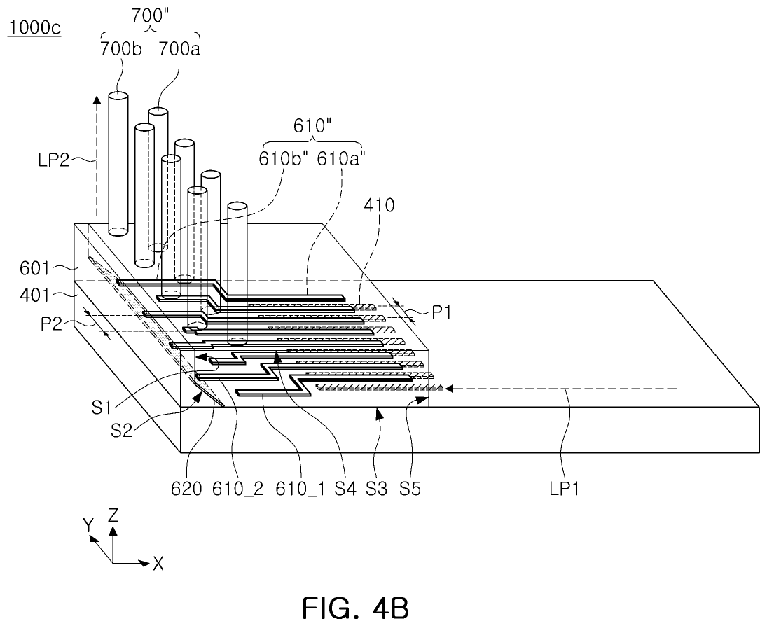

FIG. 4A is a schematic perspective view of an integrated circuit package illustrating a path of an optical signal transmitted to an optical fiber of an integrated circuit package 1000 according to an embodiment of the present inventive concept. Referring to FIG. 4A, the integrated circuit package 1000 may include a first waveguide structure 410 in a photonic integrated circuit substrate 401, a second waveguide structure 610 in an optical bridge substrate 601 disposed on the photonic integrated circuit substrate 401, a reflection pattern 620 disposed on an inclined side surface S2 of the optical bridge substrate 601, and optical fibers 700 overlapping the reflection pattern 620 in a vertical direction (Z-direction).

The first waveguide structure 410 in the photonic integrated circuit substrate 401 may include a plurality of first waveguides extending in a first direction (X-direction) and spaced apart from each other in a second direction (Y-direction). The optical bridge substrate 601 may be disposed on the photonic integrated circuit substrate 401. The second waveguide structure 610 embedded in the optical bridge substrate 601 may include a plurality of second waveguides extending in the first direction (X-direction) and spaced apart from each other in the second direction (Y-direction). Each of the plurality of second waveguides of the second waveguide structure 610 may include a first portion 610a overlapping the first waveguide structure 410 and a second portion 610b extending from the first portion 610a and overlapping the optical fibers 700 in the vertical direction (Z-direction). A portion of the above second portion 610b may overlap the optical fiber 700 in the vertical direction (Z-direction).

A spacing between the plurality of first waveguides of the first waveguide structure 410 may have a first spacing P1. The spacing between the plurality of first waveguides may be a distance between the plurality of first waveguides in the second direction (Y-direction). A spacing between the first portions 610a of the plurality of second waveguides of the second waveguide structure 610 may have the first spacing P1. The spacing between the first portions 610a of the plurality of second waveguides may be a distance between the first portions 610a of the plurality of second waveguides in a second direction (Y-direction). A spacing between the second portions 610b of the plurality of second waveguides of the second waveguide structure 610 may have a second spacing P2. The spacing between the second portions 610b of the plurality of second waveguides may be the distance in the second direction (Y-direction) of the second portions 610b of the plurality of second waveguides. The second spacing P2 may be greater than the first spacing P1. For example, the first spacing P1 may be about 550 nm, and the second spacing P2 may be about 127 μm.

A first optical signal LP1 transmitted through the first waveguide structure 410 may be transmitted to the second waveguide structure 610. The first optical signal LP1 transmitted to the second waveguide structure 610 may be a second optical signal LP2 whose optical path direction is changed by the reflection pattern 620. The second optical signal LP2 may be transmitted to the optical fiber 700.

The optical fibers 700 may include a plurality of optical fibers extending in the vertical direction (Z-direction) and spaced apart from each other in the second direction (Y-direction). Each of the optical fibers 700 may overlap a portion of the second portions (610b) of the plurality of second waveguides in the vertical direction (Z-direction). The optical fibers 700 may be disposed in correspondence to the plurality of second waveguides of the second waveguide structure 610. The number of optical fibers 700 may correspond to the number of the plurality of second waveguides spaced apart in the second direction (Y-direction). For example, when the number of the plurality of second waveguides spaced apart in the second direction (Y-direction) is 8, the number of optical fibers 700 may also be 8.

An integrated circuit package according to embodiments of the present inventive concept includes the first waveguide structure 410 having the first spacing P1 between a plurality of first waveguides and the second waveguide structure 610 having the second spacing P2 between the second portions 610b of the plurality of second waveguides on the first waveguide structure 410, wherein the second spacing P2 may be greater than the first spacing P1. Accordingly, even if the spacing between the plurality of first waveguides of the first waveguide structure 410 of the photonic integrated circuit die 400 is fixed, an optical signal may be transmitted from the first waveguide structure 410, and the second waveguide structure including the plurality of second waveguides corresponding to the spacing between the optical fibers 700 may be disposed. That is, the coupling space in the photonic integrated circuit die 400 may be reduced, thereby reducing a manufacturing process cost of an integrated circuit package and providing an integrated circuit package with increased integration.

FIG. 4B is a schematic perspective view of an integrated circuit package 1000c illustrating a path of an optical signal transmitted to an optical fiber of an integrated circuit package according to another embodiment of the present inventive concept. Referring to FIG. 4B, the remaining configurations of the integrated circuit package 1000c except for a second waveguide structure 610″ and optical fibers 700″ may be identical or corresponding to the configurations illustrated in FIG. 4A. For the components among the configurations that are identical or corresponding to the configurations illustrated in FIG. 4A except for the second waveguide structure 610″ and the optical fibers 700″, a duplicate description will be omitted.

Referring to FIG. 4B, the integrated circuit package 1000c may include a first waveguide structure 410 in a photonic integrated circuit substrate 401, a second waveguide structure 610″ in an optical bridge substrate 601 disposed on the photonic integrated circuit substrate 401, a reflection pattern 620 disposed on an inclined side surface S2 of the optical bridge substrate 601, and optical fibers 700″ overlapping the reflection pattern 620 in a vertical direction (Z-direction).

The first waveguide structure 410 in the photonic integrated circuit substrate 401 may include a plurality of first waveguides extending in a first direction (X-direction) and spaced apart from each other in a second direction (Y-direction). The optical bridge substrate 601 may be disposed on the photonic integrated circuit substrate 401. The second waveguide structure 610″ embedded in the optical bridge substrate 601 may include a plurality of second waveguides extending in the first direction (X-direction) and spaced apart from each other in a second direction (Y-direction). The plurality of second waveguides of the second waveguide structure 610″ may include a (2-1)-th waveguide 610_1 and a (2-2)-th waveguide 610_2 alternately disposed in the second direction (Y-direction). In an example, each of the (2-1)-th waveguide 610_1 and the (2-2)-th waveguide 610_2 may include a first portion 610a″ extending in the first direction (X-direction) and overlapping the first waveguide structure 410, and a second portion 610b″ extending from the first portion 610a″ and overlapping the optical fibers 700″ in the vertical direction (Z-direction).

In an example, a length of the (2-1)-th waveguide 610_1 in the first direction (X-direction) may be less than a length of the (2-2)-th waveguide 610_2 in the first direction (X-direction). In an example, the (2-1)-th waveguide 610_1 may be disposed adjacent to the first waveguide structure 410 rather than the (2-2)-th waveguide 610_2. The optical fibers 700 may include first optical fibers 700a extending in the vertical direction (Z-direction) and overlapping with the second portion 610b″ of a (2-1)-th waveguide 610_1, and second optical fibers 700b extending in the vertical direction (Z-direction) and overlapping with the second portion 610b″ of the (2-2)-th waveguide 610_2. The first optical fibers 700a and the second optical fibers 700b may be disposed in a matrix type in which they are disposed in an intersecting manner. The first optical fibers 700a may be disposed adjacent to the first waveguide structure 410 rather than the second optical fibers 700b.

A first optical signal LP1 transmitted through the first waveguide structure 410 may be transmitted to the (2-1)-th waveguide 610_1 and the (2-2)-th waveguide 610_2, and the first optical signal LP1 transmitted through the (2-1)-th waveguide 610_1 and the (2-2)-th waveguide 610_2 may become a second optical signal LP2 whose optical path direction is changed by the reflection pattern 620. The second optical signal LP2 may be transmitted to the optical fiber 700. A length of a path of the optical signal passing through the first waveguide structure 410 and the (2-1)-th waveguide 610_1 may be less than a length of a path of the optical signal passing through the first waveguide structure 410 and the (2-2)-th waveguide 610_2.

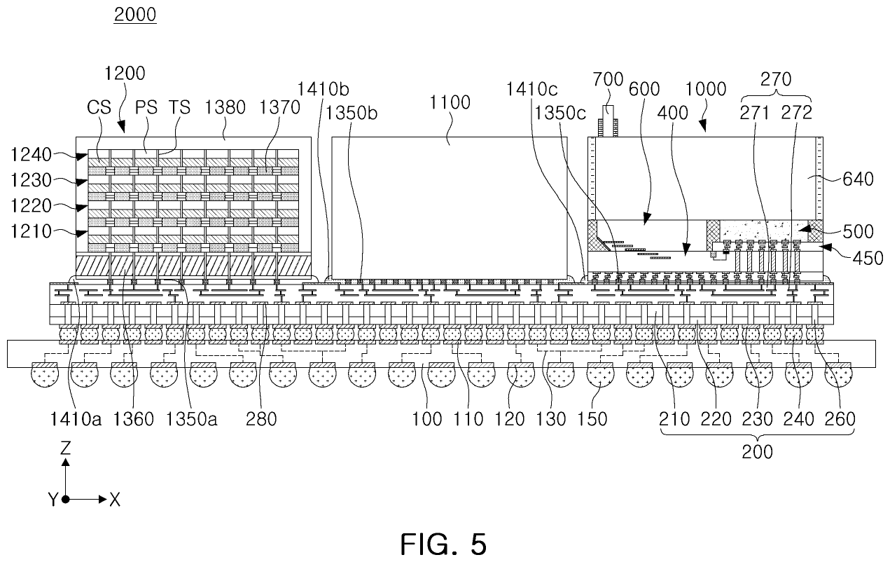

FIG. 5 is a cross-sectional view showing a package module device 2000 including the integrated circuit package of FIG. 1. Referring to FIG. 5, the package module device 2000 includes a module substrate 100, an interposer 200, and an interconnection structure 270 on the interposer 200, and a first semiconductor structure 1000, a processor chip 1100, and a second semiconductor structure 1200 may be disposed on the interconnection structure 270.

The module substrate 100 may include an upper pad 110 disposed on an upper surface of a body thereof, a lower pad 120 disposed on a lower surface of the body, and a redistribution circuit 130 electrically connecting the upper pad 110 and the lower pad 120. In an example, the module substrate 100 may be a support substrate on which the interposer 200 is disposed, and may be an integrated circuit package substrate including a printed circuit board (PCB), a ceramic substrate, a glass substrate, a tape wiring substrate, and the like.

The body of the module substrate 100 may include a different material depending on a type of the substrate. For example, if the module substrate 100 is a printed circuit board, it may be in the form of a body copper-clad stack plate or a copper-clad stack plate with an interconnection layer additionally stacked on one surface or both surfaces thereof. In an example, a solder resist layer may be formed on the lower surface and the upper surface of the module substrate 100, respectively. The upper and lower pads 110 and 120 and the redistribution circuit 130 may form an electrical path connecting an upper surface and a lower surface of the module substrate 100. The upper and lower pads 110 and 120 and the redistribution circuit 130 may include a metal material. The above metal material may include at least one metal selected from the group consisting of copper (Cu), aluminum (Al), nickel (Ni), silver (Ag), gold (Au), platinum (Pt), tin (Sn), lead (Pb), titanium (Ti), chromium (Cr), palladium (Pd), indium (In), zinc (Zn), or carbon (C), or an alloy including two or more metals. In an example, the redistribution circuit 130 may include multiple redistribution layers and vias connecting them. An external connection terminal 150 connected to the lower pad 120 may be disposed on the lower surface of the module substrate 100. In an example, the external connection terminal 150 may include tin (Sn), indium (In), bismuth (Bi), antimony (Sb), copper (Cu), silver (Ag), zinc (Zn), lead (Pb), and/or an alloy thereof.

The interposer 200 may include a substrate 210, a lower protective layer 220, a lower pad 230, a bump 240, and a through-electrode 260. In an example, the first semiconductor structure 1000, the processor chip 1100, and the second semiconductor structure 1200 may be stacked on the module substrate 100 via the interposer 200 and the interconnection structure 270. In an example, the interposer 200 may electrically connect the first semiconductor structure 1000, the processor chip 1100, and the second semiconductor structure 1200. In an example, the substrate 210 may be formed of any one of a silicon substrate, an organic substrate, a plastic substrate, and a glass substrate. When the substrate 210 is a silicon substrate, the interposer 200 may be referred to as a silicon interposer. In the interposer 200, when the substrate 210 is an organic substrate, the interposer 200 may be referred to as a panel interposer. In an example, the lower protective layer 220 may be disposed on a lower surface of the substrate 210, and the lower pad 230 may be disposed below the lower protective layer 220. The lower pad 230 may be connected to a through-electrode 260. The first semiconductor structure 1000, the processor chip 1100, and the second semiconductor structure 1200 may be electrically connected through the bumps 240 disposed below the lower pad 230.

The interconnection structure 270 may be disposed on an upper surface of the substrate 210, and may include an insulating layer 271 and a single-layer or a multi-layer interconnection layer 272. When the interconnection structure 270 has a multi-layer interconnection structure, interconnections of different layers may be connected to each other through vertical contacts.

The through-electrode 260 may extend from the upper surface to the lower surface of the substrate 210 and penetrate the substrate 210. The through-electrode 260 may be electrically connected to the interconnections of the interconnection structure 270 by being connected to a pad 280. In an example, when the substrate 210 is a silicon substrate, the through-electrode 260 may be referred to as a through silicon via (TSV). In an example, the interposer 200 may include only the interconnection layer therein, and may not include the through-electrode 260. The interposer 200 may be used for the purpose of converting or transmitting an input electrical signal between the module substrate 100, and the first semiconductor structure 1000, the processor chip 1100 and the second semiconductor structure 1200. That is, the interposer 200 may not include components such as active elements or passive elements. According to some embodiments, the interconnection structure 270 may be disposed below the through-electrode 260. For example, a positional relationship between the interconnection structure 270 and the through-electrode 260 may be relative.

The electrically conductive bump 240 may be disposed on a lower surface of the interposer 200, and may be electrically connected to an interconnection of the interconnection structure 270. The interposer 200 may be stacked on the module substrate 100 through the bump 240. The bump 240 may be connected to the interconnection layer 272 of the interconnection structure 270 through the through-electrode 260 and the lower pad 230. In an example, some of the lower pads 230 used for power or ground may be integrated and connected together to the bumps 240, so that the number of the lower pad 230 may be greater than the number of the bump 240.

The first semiconductor structure 1000 may correspond to the integrated circuit package 1000 of FIG. 1. The processor chip 1100 may include, for example, a central processing unit (CPU), a graphic processing unit (GPU), a field programmable gate array (FPGA), a digital signal processor (DSP), an encryption processor, a microprocessor, a microcontroller, an analog-to-digital converter, an application-specific IC (ASIC), and the like. Depending on types of elements included in the processor chip 1100, the package module device 2000 may be classified into a server-oriented integrated circuit package or a mobile-oriented integrated circuit package.

The second semiconductor structure 1200 may include a base substrate 1360, a plurality of semiconductor chips 1210, 1220, 1230 and 1240, an adhesive material layer 1370 between the plurality of semiconductor chips 1210, 1220, 1230 and 1240, and a mold layer 1380.

The base substrate 1360 may be a buffer semiconductor chip or a logic semiconductor chip. In an example, the base substrate 1360 may have a width or a size greater than that of the plurality of semiconductor chips 1210, 1220, 1230 and 1240.

The plurality of semiconductor chips 1210, 1220, 1230 and 1240 may be vertically stacked on the base substrate 1360. As shown, the plurality of semiconductor chips 1210, 1220, 1230 and 1240 may include first to fourth semiconductor chips 1210 to 1240. In an example, the first to fourth semiconductor chips 1210 to 1240 may be sequentially stacked on the base substrate 1360 in a third direction (Z-direction).

The plurality of semiconductor chips 1210, 1220, 1230 and 1240 are illustrated as including four semiconductor chips, but are not limited thereto. For example, they may include more than four semiconductor chips. The plurality of semiconductor chips 1210, 1220, 1230 and 1240 are illustrated as having the same shape, but are not limited thereto. For example, the plurality of semiconductor chips 1210, 1220, 1230 and 1240 may include different types of semiconductor chips or different shapes of semiconductor chips. In an example, the plurality of semiconductor chips 1210, 1220, 1230 and 1240 may be memory semiconductor chips such as DRAMs.

Each of the plurality of semiconductor chips 1210, 1220, 1230 and 1240 may include a first chip structure CS, a second chip structure PS disposed on the first chip structure CS, and a connection structure TS penetrating the first chip structure CS and the second chip structure PS.

The adhesive material layer 1370 may surround a space between the first semiconductor chip 1210 and the base substrate 1360, a space between the plurality of semiconductor chips 1210, 1220, 1230 and 1240, and side surfaces of the plurality of semiconductor chips 1210, 1220, 1230 and 1240. In an example, the adhesive material layer 1370 may include an epoxy material. For example, the adhesive material layer 1370 may be a non-conductive film (NCF), but the embodiment is not limited to such a material.

In one embodiment, the mold layer 1380 may be disposed to cover the plurality of semiconductor chips 1210, 1220, 1230 and 1240 and the adhesive material layer 1370 to protect the plurality of semiconductor chips 1210, 1220, 1230 and 1240 and the adhesive material layer 1370 from an external environment. In an example, the mold layer 1380 may include an insulating material including a resin material such as an epoxy molding compound (EMC).

The package module device 2000 may include a first connection pattern 1350a electrically connecting the second semiconductor structure 1200 and the interconnection structure 270 between the second semiconductor structure 1200 and the interconnection structure 270, a second connection pattern 1350b electrically connecting the processor chip 1100 and the interconnection structure 270 between the processor chip 1100 and the interconnection structure 270, and a third connection pattern 1350c electrically connecting the first semiconductor structure 1000 and the interconnection structure 270 between the first semiconductor structure 1000 and the interconnection structure 270.

The package module device 2000 may include a first underfill material layer 1410a filled between the second semiconductor structure 1200 and the interconnection structure 270 and surrounding a side surface of the first connection pattern 1350a, a second underfill material layer 1410b filled between the second semiconductor structure 1200 and the interconnection structure 270 and surrounding a side surface of the second connection pattern 1350b, and a third underfill material layer 1410c filled a space between the second semiconductor structure 1200 and the interconnection structure 270 and surrounding a side surface of the third connection pattern 1350c.

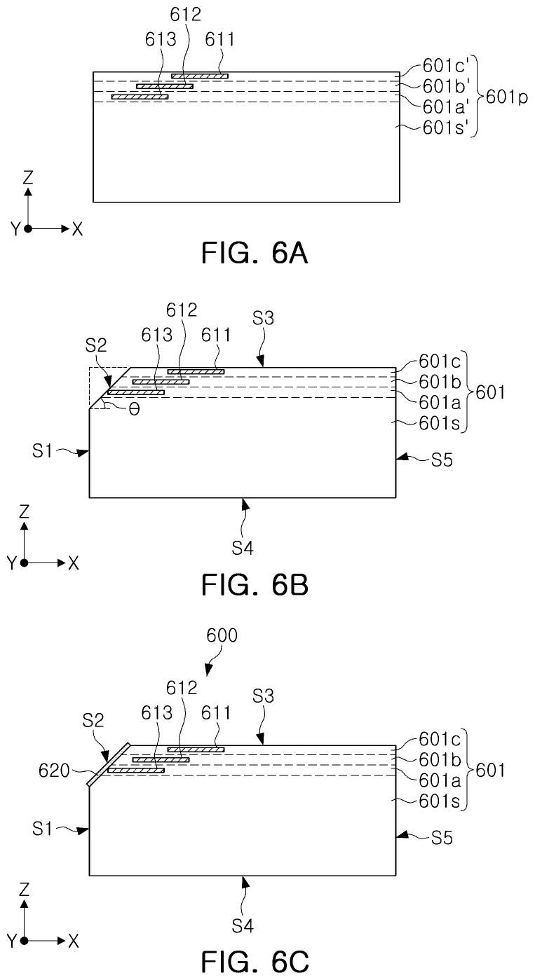

FIGS. 6A to 6C are drawings illustrating an embodiment of a method for manufacturing the optical bridge structure of FIG. 1. Referring to FIG. 6A, the method may include an operation of sequentially stacking a first optical waveguide structure 601a′ and 613, a second optical waveguide structure 601b′ and 612, and a third optical waveguide structure 601c′ and 611 on an upper surface of an optical bridge main substrate 601s′ to form an optical bridge preliminary substrate 601p.

The first optical waveguide structure 601a′ and 613 may include a first preliminary insulating substrate 601a′ and a (2-3)-th optical waveguide 613 in the first preliminary insulating substrate 601a′, the second optical waveguide structure 601b′ and 612 may include a second preliminary insulating substrate 601b′ and a (2-2)-th optical waveguide 612 in the second preliminary insulating substrate 601b′, and the third optical waveguide structure 601c′ and 611 may include a third preliminary insulating substrate 601c′ and a (2-1)-th optical waveguide 611 in the third preliminary insulating substrate 601c′.

In the first optical waveguide structure 601a′ and 613, the first preliminary insulating substrate 601a′ may be etched to form a recess defining the (2-3)-th optical waveguide 613. In the second optical waveguide structure 601b′ and 612, the second preliminary insulating substrate 601b′ may be etched to form a recess defining the (2-2)-th optical waveguide 612 to overlap a portion of the (2-3)-th optical waveguide 613 in a vertical direction (Z-direction). In the third optical waveguide structure 601c′ and 611, the third preliminary insulating substrate 601c′ may be etched to form a recess defining the (2-1)-th optical waveguide 611 to overlap a portion of the (2-2)-th optical waveguide 612 in the vertical direction (Z-direction). The (2-3)-th optical waveguide 613, the (2-2)-th optical waveguide 612, and the (2-1)-th optical waveguide 611 may form a stepped shape continuously arranged in a first direction (X-direction). The (2-1)-th optical waveguide 611, the (2-2)-th optical waveguide 612, and the (2-3)-th optical waveguide 613 may form a second waveguide structure (e.g., the second waveguide structure 610 in FIG. 1).

Referring to FIG. 6B, an optical bridge substrate 601 including an inclined side surface S2 may be formed by means of a laser and/or etching process on the optical bridge main substrate 601s′, the first insulating substrate 601a′, the second insulating substrate 601b′, and the third insulating substrate 601c′ of the optical bridge preliminary substrate 601p to form an optical bridge main substrate 601s, a first insulating substrate 601a, a second insulating substrate 601b, and a third insulating substrate 601c of an optical bridge preliminary substrate 601. The inclined side surface S2 may be in contact with an end of the (2-3)-th optical waveguide 613 and have a width decreasing toward the third insulating substrate (601c) in the first direction (X-direction).

The optical bridge substrate 601 may include a first side surface S1 adjacent to the (2-3)-th optical waveguide 613, a second side surface S5 facing the first side surface S1, an upper surface S3 of the third insulating substrate 601c, the inclined side surface S2 formed between the first side surface S1 and the upper surface S3 of the third insulating substrate 601c, and a lower surface S4 of the optical bridge main substrate 601s.

The inclined side surface S2 may be preferably formed at about 45° with respect to the lower surface S4 of the optical bridge main substrate 601s so that an end of the third optical waveguide 613 can be in contact therewith in order to allow an optical signal to be routed out of the (2-3)-th optical waveguide 613. For example, the inclined side surface S2 may be at about 38° to about 52° with respect to the lower surface S4 of the optical bridge main substrate 601s.

Referring to FIG. 6C, a reflection pattern 620 may be formed on the inclined side surface S2 of the optical bridge substrate 601. The reflection pattern 620 formed on the inclined side surface S2 of the optical bridge substrate 601 may form an optical bridge structure 600 together with the optical bridge main substrate 601s, the first optical waveguide structure 601a and 613, the second optical waveguide structure 601b and 612, and the third optical waveguide structure 601c, and 611.

The reflection pattern 620 may act as a reflection mirror on which the optical signal transmitted through the first optical waveguide 611, the second optical waveguide 612, and the third optical waveguide 613 undergoes total reflection. The reflection pattern 620 may include a metal material, and may include, for example, a metal such as Au, Ag, Al, Mg, Cu, Pt, Pd, Ni, or Cr.

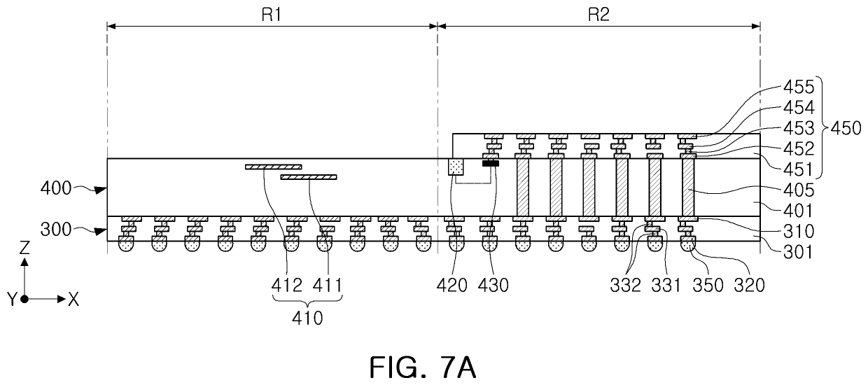

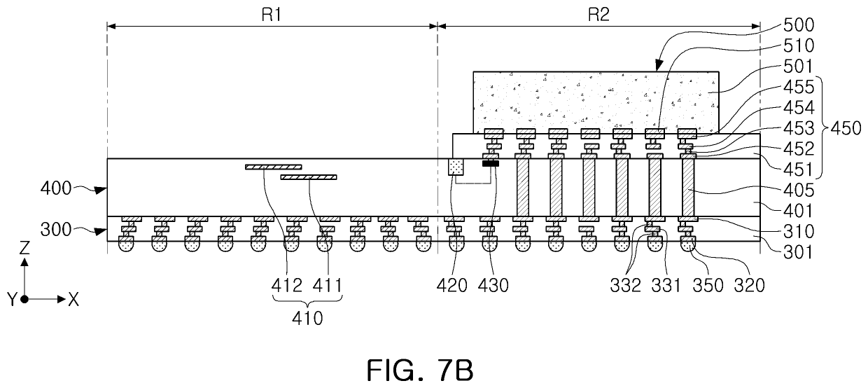

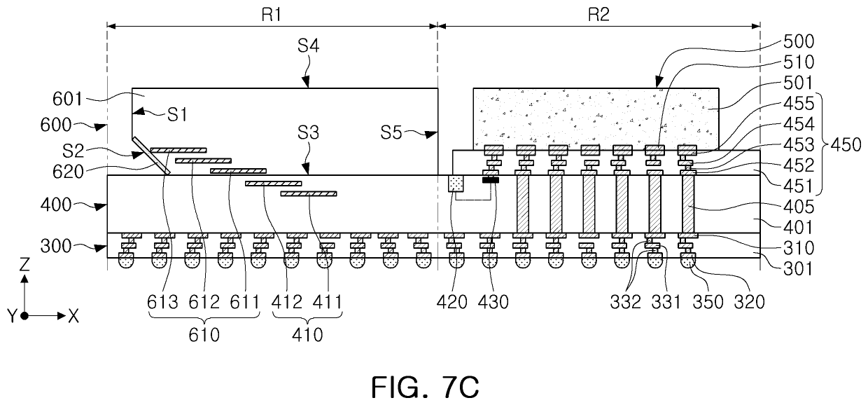

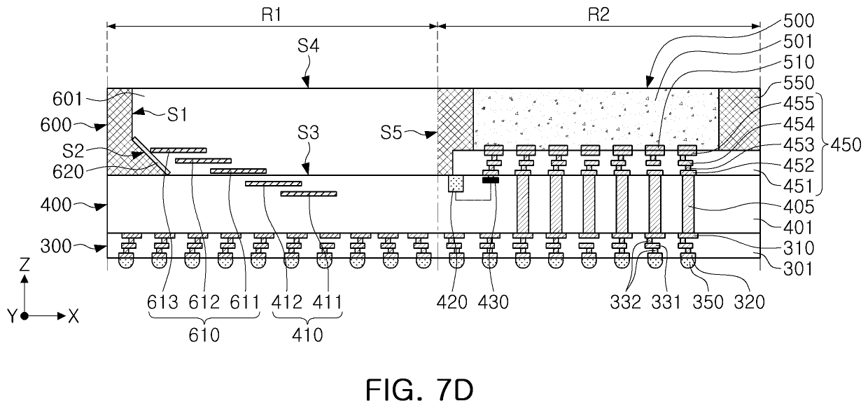

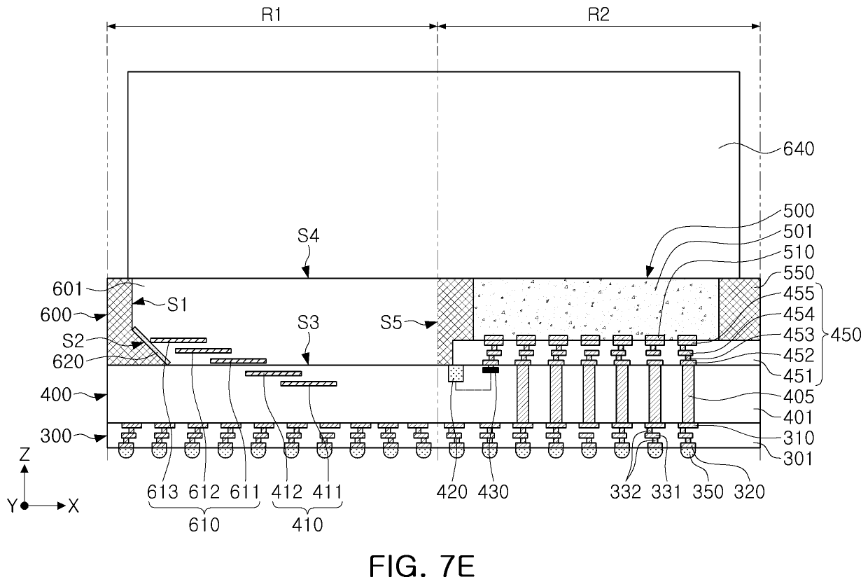

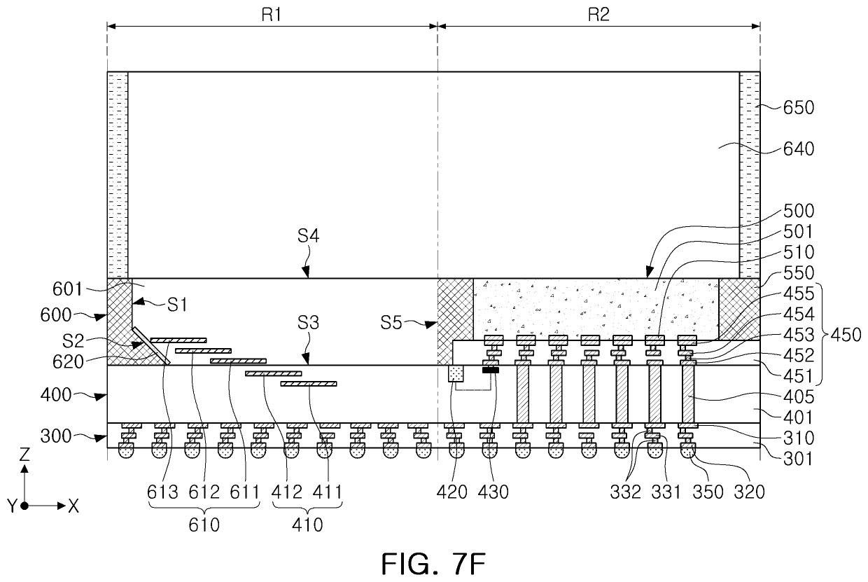

FIGS. 7A to 7F are drawings illustrating an embodiment of a method for manufacturing an integrated circuit package of FIG. 1. A method for manufacturing an integrated circuit package according to embodiments of the present inventive concept may comprise forming a photonic integrated circuit die 400 on a second redistribution structure 300 and forming a first redistribution structure 450 on a second region R2 of the photonic integrated circuit die 400 (see FIG. 7A), forming an electronic integrated circuit die 500 on the first interconnection structure 450 (see FIG. 7B), forming an optical bridge structure 600 on the first region R1 of the photonic integrated circuit die 400 (see FIG. 7C), forming a first mold portion 550 on an upper surface of the photonic integrated circuit die 400 (see FIG. 7D), forming a dummy structure 640 on the first mold portion 550, the optical bridge structure 600, and the electronic integrated circuit die 500 (see FIG. 7E), and forming a second mold portion 650 surrounding a side surface of the dummy structure 640 on the first mold portion 550 (see FIG. 7F).

Referring to FIG. 7A, prior to forming the photonic integrated circuit die 400, the method for manufacturing the integrated circuit package may include forming a second redistribution structure 300. The operation of forming the second redistribution structure 300 may include forming a second lower interconnection layer 331 and 332 to be embedded in the second substrate 301, forming a second upper pad 310 on an upper surface of the second substrate 301, and forming a second lower pad 320 on a lower surface of the second substrate 301. The operation of forming the second redistribution structure 300 may include forming an external connection terminal 350 on the lower surface of the second substrate 301.

The operation of forming the photonic integrated circuit die 400 may include forming a cavity in the photonic integrated circuit substrate 401 in the first region R1 by means of a laser and/or etching process. A first waveguide structure 410 may be formed in the cavity. A modulator 420 and a passive element 430 may be formed in a region adjacent to the first waveguide structure 410. The operation of forming the photonic integrated circuit die 400 may include forming a connection structure 405 penetrating the photonic integrated circuit substrate 401. The operation of forming the connection structure 405 may include penetrating the photonic integrated circuit substrate 401 by means of a laser drilling or etching process and filling the photonic integrated circuit substrate 401 with a conductive material by means of a plating process. The conductive material may include at least one of tungsten (W), copper (Cu), aluminum (Al), or an alloy thereof.

After the operation of forming the photonic integrated circuit die 400, the first redistribution structure 450 may be formed on the second region R2 of the photonic integrated circuit substrate 401. The operation of forming the first redistribution structure 450 may include forming a first substrate 451 on the connection structure 405 of the photonic integrated circuit die 400, forming a first lower interconnection layer 453 and 454 to be embedded in the first substrate 451, forming a first upper pad 455 on an upper surface of the first substrate 451, and forming a first lower pad 452 on a lower surface of the first substrate 451.

Referring to FIG. 7B, the first redistribution structure 450 and the electronic integrated circuit die 500 may be connected to each other by means of a bonding manner. The bonding between the first upper pad 455 of the first redistribution structure 450 and a connection pad 510 of the electronic integrated circuit substrate 501 may be a copper-copper (Cu—Cu) bonding. Although not shown in the drawing, the bonding may include a bonding between an insulating layer (not shown) on an upper surface of the first redistribution structure 450 and an insulating layer (not shown) on a lower surface of the electronic integrated circuit die 500. The bonding between the insulating layers may be a dielectric-dielectric bonding, such as an SiCN—SiCN bonding. The first redistribution structure 450 and the electronic integrated circuit die 500 may be bonded by means of hybrid bonding including a Cu—Cu bonding and a dielectric-dielectric bonding.

Referring to FIG. 7C, an optical bridge structure 600 may be formed on the photonic integrated circuit die 400. The optical bridge structure 600 in FIG. 6C may be disposed in a flipped state so that the first side surface S1 of the optical bridge structure 600 is disposed on an edge of the photonic integrated circuit die 400, and an upper surface S3 of a third substrate (e.g., the third insulating substrate 601c in FIG. 6C) is in contact with an upper surface of the photonic integrated circuit substrate 401. The optical bridge structure 600 including the second waveguide structure 610 and the reflection pattern 620 may be manufactured with reference to FIGS. 6A to 6C.

Referring to FIG. 7D, a first mold portion 550 may be formed on the photonic integrated circuit die 400. The first mold portion 550 may be formed to cover the optical bridge structure 600 and the electronic integrated circuit die 500, and then formed so that an upper surface of the optical bridge structure 600 and an upper surface of the electronic integrated circuit die 500 are exposed by means of a planarization process. An upper surface of the first mold portion 550, the upper surface of the optical bridge structure 600, and the upper surface of the electronic integrated circuit die 500 may be disposed on the same level. The first mold portion 550 may include a first mold material, and may include, for example, TetraEthyl Ortho Silicate (TEOS).

Referring to FIG. 7E, a dummy structure 640 may be formed on the first mold portion 550, the optical bridge structure 600, and the electronic integrated circuit die 500. The dummy structure 640 may be a height-assistant structure for adjusting a height of the integrated circuit package 1000 in FIG. 1.

Referring to FIG. 7F, a second mold portion 650 may be formed on the first mold portion 550, the optical bridge structure 600, and the electronic integrated circuit die 500. The second mold portion 650 may be formed to cover the dummy structure 640, and then formed so that the upper surface of the dummy structure 640 is exposed by means of a planarization process. The second mold portion 650 may include a second mold material different from the first mold material, and may include, for example, an EMC (epoxy molding compound).

Next, referring to FIG. 1 together, an optical fiber 700 may be formed on the dummy structure 640. The optical fiber 700 may be formed to overlap the reflection pattern 620 in the vertical direction (Z-direction). As a result, the integrated circuit package 1000 in FIG. 1 may be manufactured. However, the present inventive concept is not limited thereto, and the operation of forming the dummy structure 640 of FIG. 7E and the operation of forming the second mold portion 650 of FIG. 7F may be omitted. In this case, the optical fiber 700 may be formed on the upper surface of the optical bridge structure 600, and as a result, the integrated circuit package 1000b in FIG. 3 may be manufactured.

An integrated circuit package according to embodiments of the present inventive concept may include an optical bridge structure including a photonic integrated circuit die, an electronic integrated circuit die connected to the photonic integrated circuit die, and a second waveguide structure disposed on the photonic integrated circuit die and forming a path of an optical signal together with a first waveguide structure of the photonic integrated circuit die. Accordingly, an integrated circuit package with improved integration and optical characteristics may be provided.

However, the effects of the present inventive concept are not limited to the effects described above, and may be expanded in various ways without departing from the spirit and scope of the present inventive concept.

While example embodiments have been shown and described above, it will be apparent to those skilled in the art that modifications and variations could be made without departing from the scope of the present inventive concept as defined by the appended claims.

What is claimed is:

1. An integrated circuit package, comprising:
a photonic integrated circuit die including a first region, which has a first waveguide structure therein, and a second region, which has a connection structure therein;
an optical bridge structure having an inclined side surface and a width that narrows in a direction towards the first region of the photonic integrated circuit die, and having a second waveguide structure therein that overlaps a portion of the first waveguide structure in a vertical direction;
a first redistribution structure that extends on the second region and is electrically connected to the connection structure within the photonic integrated circuit die;
an electronic integrated circuit die extending on and electrically connected to the first redistribution structure;
a reflection pattern on the inclined side surface of the optical bridge structure; and
an optical fiber overlapping the reflection pattern in the vertical direction.

2. The package of claim 1, wherein an upper surface of the optical bridge structure is coplanar with an upper surface of the electronic integrated circuit die.

3. The package of claim 1, wherein the optical bridge structure comprises a lower surface in contact with the photonic integrated circuit die, a first side surface adjacent to an edge of the photonic integrated circuit die, and a second side surface facing the first side surface and adjacent to one surface of the electronic integrated circuit die; and wherein the inclined side surface of the optical bridge structure extends between and intersects the lower surface and the first side surface.

4. The package of claim 1, further comprising:
a dummy structure on the optical bridge structure and the electronic integrated circuit die; and
a first mold portion surrounding a side surface of the dummy structure and comprising a first mold material.

5. The package of claim 4, wherein the optical fiber is in contact with an upper surface of the dummy structure.

6. The package of claim 4, wherein an upper surface of the optical bridge structure and an upper surface of the electronic integrated circuit die are in contact with a lower surface of the dummy structure.

7. The package of claim 4, further comprising:
a second mold portion extending: on a side surface of the optical bridge structure, between the optical bridge structure and the first redistribution structure, and on a side surface of the electronic integrated circuit die.

8. The package of claim 7, wherein the second mold portion comprises a second mold material, which is different from the first mold material.

9. The package of claim 1, wherein the first redistribution structure comprises a third side surface facing one surface of the optical bridge structure and a fourth side surface facing the third side surface; and wherein the fourth side surface of the first redistribution structure is coplanar with a side surface of the photonic integrated circuit die.

10. The package of claim 1, wherein the reflection pattern comprises at least one of titanium oxide (TiO₂) and copper (Cu).

11. The package of claim 1, wherein the optical fiber is in direct contact with an upper surface of the optical bridge structure.

12. The package of claim 1, further comprising:
a second redistribution structure, which extends on a lower surface of the photonic integrated circuit die, and is connected to the connection structure; and
a connection bump on a lower surface of the second redistribution structure.

13. The package of claim 1, wherein the photonic integrated circuit die further comprises a photonic modulator electrically connected to the first redistribution structure.

14. The package of claim 1, wherein the second waveguide structure comprises a first waveguide and a second waveguide on a higher level than the first waveguide and adjacent to the reflection pattern than the first waveguide; and wherein the second waveguide does not overlap the first waveguide structure in the vertical direction.

15. An integrated circuit package, comprising:
a first die comprising a first region, which includes a plurality of first waveguides therein that are spaced apart from each other in a first horizontal direction, and a second region, which is spaced apart from the first region in a second horizontal direction intersecting the first horizontal direction and includes a connection structure;
an optical bridge structure having a side surface that is inclined so that its width decreases toward the first die on the first region, and including a plurality of second waveguides adjacent to the inclined side surface and spaced apart from each other in the first horizontal direction;
a first redistribution structure extending on the second region and connected to the connection structure;
a second die extending on the first redistribution structure, and connected to the first redistribution structure;
a reflection pattern on the inclined side surface of the optical bridge structure; and
an optical fiber overlapping the reflection pattern in a vertical direction;
wherein each of the plurality of second waveguides comprise a first portion overlapping the plurality of first waveguides in the vertical direction and a second portion extending from the first portion and being in contact with the reflection pattern; and
wherein a spacing between the plurality of first waveguides is less than a spacing between the second portions of the plurality of second waveguides.

16. The package of claim 15, further comprising:
a second redistribution structure extending on a lower surface of the first die, and connected to the connection structure; and
wherein the second redistribution structure overlaps the optical bridge structure and the first redistribution structure in the vertical direction.

17. The package of claim 15, wherein the plurality of second waveguides overlap with a portion of the plurality of first waveguides in the vertical direction.

18. The package of claim 15,
wherein the optical bridge structure comprises a lower surface in contact with the first die, a first side surface adjacent to an edge of the first die, and a second side surface adjacent to the second die and facing the first side surface;
wherein the inclined side surface of the optical bridge structure connects the lower surface and the first side surface; and
wherein the integrated circuit package further comprises a mold portion exposing an upper surface of the optical bridge structure and an upper surface of the second die on the first die.

19. The package of claim 15, wherein a spacing between the plurality of first waveguides is about 550 nm; and wherein a spacing between the plurality of second waveguides is about 127 μm.

20. An integrated circuit package, comprising:
a photonic integrated circuit die including a first region, which has a first waveguide extending in a first horizontal direction therein, and a second region, which is spaced apart from the first region in the first horizontal direction and includes a connection structure therein;
an optical bridge structure having an inclined side surface of which a width decreases toward the photonic integrated circuit die on the first region, and including a second waveguide extending adjacent to the inclined side surface and overlapping a portion of the first waveguide in a vertical direction;
a first redistribution structure extending on the second region, and connected to the connection structure;
a second redistribution structure extending on a lower surface of the photonic integrated circuit die, and connected to the connection structure;
an electronic integrated circuit die extending on the first redistribution structure, and connected to the first redistribution structure;
a reflection pattern on the inclined side surface of the optical bridge structure; and
an optical fiber overlapping the reflection pattern in the vertical direction;
wherein a first distance in the first horizontal direction between the first waveguide and the reflection pattern is greater than a second distance in the first horizontal direction between the second waveguide and the reflection pattern.
